(19) United States
(12) Patent Application Publication
(10) Pub. No.: US 2024/0075839 A1
(43) Pub. Date: Mar. 7, 2024

(54) HEATED EV CHARGE COUPLER

(71) Applicant: GM GLOBAL TECHNOLOGY OPERATIONS LLC, Detroit, MI (US)

(72) Inventors: Brandon R. Jones, White Lake Township, MI (US); Kodjo M. Lee, Superior Township, MI (US); Nathan C. Adams, Clarkston, MI (US); Michael E. Pedigo, Howell, MI (US); Denise A. Burns, Lake Orion, MI (US)

(73) Assignee: GM GLOBAL TECHNOLOGY OPERATIONS LLC, Detroit, MI (US)

(21) Appl. No.: 17/939,265

(22) Filed: Sep. 7, 2022

(51) Int. Cl. B60L 53/60; B60L 53/16; B60L 53/302; B60L 53/31; H02J 7/00

(52) U.S. Cl. CPC B60L 53/60; B60L 53/16; B60L 53/302; B60L 53/31; H02J 7/0042; H02J 7/0047

(57) ABSTRACT

An electric vehicle supply equipment (EVSE) charging station for charging a propulsion battery pack of an electric vehicle (EV) includes a charging cabinet, an electrical cable, and a charge coupler. The charging station is operable for providing a charging voltage or current to the battery pack during a charging operation. The electrical cable has a distal end connected to the charging cabinet. The charge coupler is connected to a proximal end of the electrical cable and connects to a charge receptacle of the EV. The charge coupler includes at least one heating element connected to the charge coupler. The heating element is configured to selectively heat the charge coupler in response to the environmental state being indicative of accumulated snow or ice on the charge coupler.

### INTRODUCTION

Electrochemical battery packs serve as onboard power supplies in a myriad of mobile and stationary battery electric systems. Aboard an electric vehicle (EV), for example, a high-voltage propulsion battery pack may be arranged on a direct current (DC) voltage bus. The battery pack is constructed from an application-suitable number of battery cells, with modern EV battery cells typically having a lithium-ion, nickel-metal hydride, or nickel-cadmium chemistry. The DC voltage bus and connected battery pack ultimately power one or more electric traction motors and associated power electronic components during battery discharging modes. The constituent battery cells of the battery pack are then periodically recharged by an offboard electric vehicle supply equipment (EVSE) charging station when the EV is idle, or via regenerative braking during vehicle operation.

In a typical battery charging process, a charge receptacle located on a body of the EV is connected to the EVSE charging station via a charge plug or coupler, e.g., a J1772, CHAdeMO, CCS, or other multi-pin AC or DC charge coupler. Depending on the relevant charging standard, the battery pack may undergo an AC-based charging process using standard household voltages (AC Level 1), e.g., 110-120V, or AC Level 2 chargers enable faster charging times relative to those achievable via AC Level 1 using a higher voltage, for instance a 208V-240V charging outlet. DC fast charging (DCFC) in contrast provides the fastest possible charging times by delivering a DC voltage and charging current directly to the propulsion battery pack, i.e., without the need for AC-to-DC power conversion.

### SUMMARY

Disclosed herein are systems and methods for heating a charge coupler of an offboard electric vehicle supply equipment (EVSE) charging station. As with conventional gasoline pumps, an EVSE charging station is typically located outside. During cold winter months or inclement weather, snow or ice may accumulate on the charge coupler and other exposed charging equipment. At times, the accumulated snow/ice could become lodged in exposed cavities or on surfaces of the charge coupler, which in turn interferes with a proper connection of the charge coupler and a mating charge receptacle of the EV. The present solutions are directed toward selectively heating the charge coupler to help melt accumulated snow and ice during or prior to a charging operation to prevent such interference. Another attendant benefit of the present teachings is the added level of personal comfort afforded to a user when grasping a warm charge coupler in cold weather conditions.

In accordance with an aspect of the disclosure, an EVSE charging station operable for charging a propulsion battery pack of an EV includes a charging cabinet, an electrical cable, and a charge coupler having or containing at least one heating element. The charging station is operable for providing a charging voltage or current to the battery pack during a charging operation. The electrical cable has a distal end and a proximal end, with the distal end of the electrical cable being connected to the charging cabinet. The charge coupler, which is connected to the proximal end of the cable, is configured to connect to a charge receptacle of the EV as noted above. In this particular embodiment, the at least one heating element is connected to the charge coupler, e.g., embedded therewithin, and is configured to selectively heat the charge coupler in response to an environmental state of the charge coupler being indicative of accumulated snow or ice thereon.

In one or more embodiments, the heating element includes a resistive heating element, e.g., a wire or coil. Alternatively, the charge coupler may include a coolant loop operable for circulating heated coolant through a coupler body of the charge coupler, in which case the heating element includes the heated coolant or related heating sources.

Aspects of the present disclosure include a sensor operable for detecting the environmental state of the charge coupler. The sensor may include a temperature sensor, in which case the environmental state of the charge coupler may include a measured temperature of the charge coupler, e.g., an internal temperature of the coupler body and/or of charging pins disposed at a plug end of the charge coupler. Other implementations of the sensor include a humidity sensor, in which case the environmental state of the charge coupler includes a humidity level of the charge coupler. Multiple sensor types may be used together in other embodiments for improved accuracy when predicting the environmental state of the charge coupler.

The charge coupler as noted above includes a plurality of charging pins. The at least one heating element in one or more embodiments may be positioned proximate the charging pins. The at least one heating element in another approach may be positioned within a handle of the coupler body and operable for warming the handle.

In another aspect of the disclosure, a method for use with the EVSE charging station includes determining the environmental state of the charge coupler via a controller of the charging station using one or more sensors, and selectively activating at least one heating element connected to the charge coupler in response to the environmental state being indicative of accumulated snow or ice on the charge coupler.

Also disclosed herein is a charge coupler for use with an EVSE charging station. The charge coupler in accordance with an aspect of the disclosure may include a coupler body having a plug end and a handle. The plug end includes a plurality of charging pins configured to connect to a charge receptacle of the EV. The handle for its part is connectable to a charging cabinet of the EVSE charging station via an electrical cable, i.e., to charging equipment housed therewithin. As part of this embodiment, a sensor is operable for detecting an environmental state of the charge coupler. At least one heating element is connected to the coupler body and configured to selectively heat the coupler body in response to the environmental state of the charge coupler being indicative of accumulated snow or ice thereon.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an exemplary electric vehicle (EV) undergoing a charging process at an electric vehicle supply equipment (EVSE) charging station equipped with a heated charge coupler in accordance with the disclosure.

FIG. 2 illustrates a charge coupler usable with the EVSE charging station of FIG. 1 according to an exemplary embodiment.

FIG. 3 is a flow chart describing a representative method for heating the charge coupler depicted in FIG. 2.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

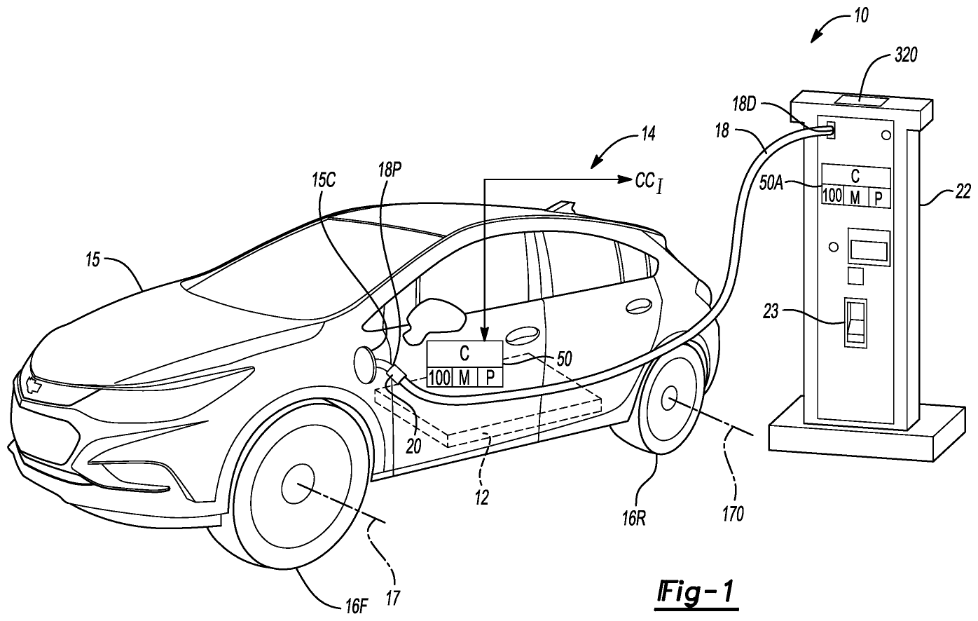

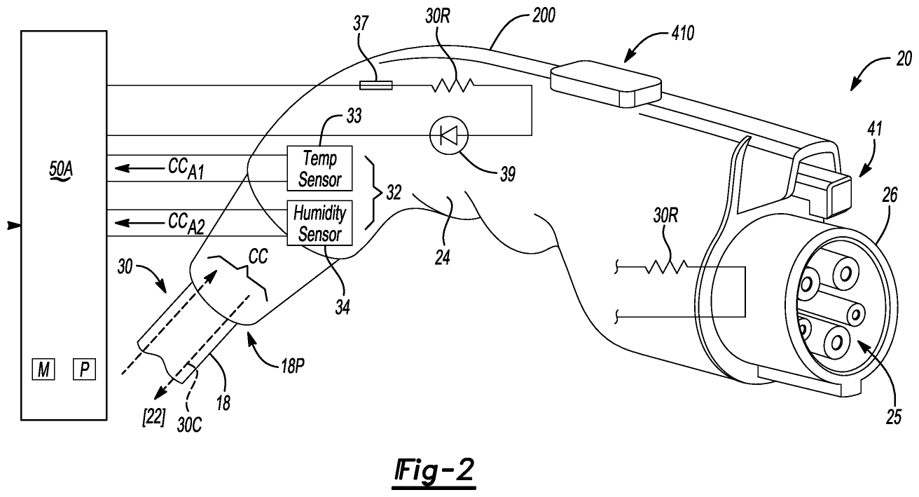

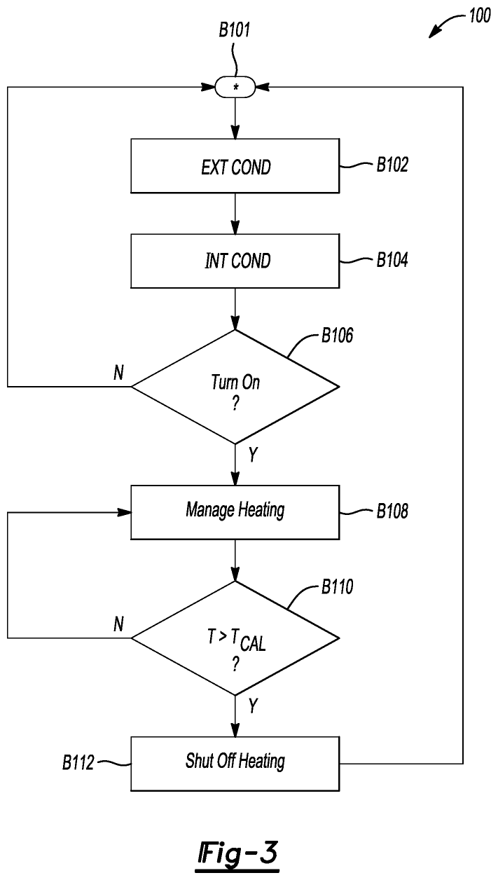

Referring to the drawings, wherein like reference numbers refer to like features throughout the several views, FIG. 1 depicts an electric vehicle supply equipment (EVSE) charging station 10 operable for charging a propulsion battery pack 12 of an electric vehicle (EV) 14. The charging station 10 is equipped with a heated coupler 20, with the heated coupler 20 and related systems described in greater detail below with reference to FIGS. 2 and 3. Use of the heated coupler 20 is intended to provide various attendant benefits to a user when performing a charging operation of the EV 14, with such benefits including but not limited to reducing accumulated snow and ice on exposed surfaces of the heated coupler 20 and improving the comfort of the user when handling the heated coupler 20.

The EV 14 of FIG. 1 may be optionally embodied as a battery electric motor vehicle, e.g., a passenger sedan, crossover vehicle, sport utility vehicle, or truck, with the present teachings also being extendable to plug-in hybrid electric vehicles of such types. The solutions described herein may also be extended to other electrified mobile systems such as but not limited to rail vehicles, factory vehicles, aircraft, marine vessels, robots, farm equipment, etc. The EV 14 illustrated in FIG. 1 is therefore intended to be illustrative of just one possible electrified system within the scope of the disclosure.

The exemplary EV 14 shown in FIG. 1 includes a vehicle body 15 and road wheels 16F and 16R, with “F” and “R” indicating the respective front and rear positions. The road wheels 16F and 16R rotate about respective axes 17 and 170, with the road wheels 16F and/or the road wheels 16R being powered by output torque from a rotary electric machine (not shown) of the EV 14, as appreciated in the art. Such an electric machine may be embodied as a polyphase/alternating current (AC) traction motor energized by the propulsion battery pack 12 and a power inverter (not shown). As appreciated by those skilled in the art, a power inverter is typically configured with control circuits including power transistors, e.g., IGBTs for transforming high-voltage DC electric power to high-voltage AC electric power, and transforming high-voltage AC electric power to high-voltage DC electric power. Although omitted for illustrative simplicity, such components and other components, e.g., an accessory power module/DC-DC-converter, onboard charging module, and other power electronics may be included in the overall structure of the EV 14.

During charging of the propulsion battery pack 12, a charge receptacle 15C of the EV 14 is connected to the EVSE station 10 via the charge coupler 20 and an electrical cable 18. A charging cabinet 22 of the EVSE charging station 10, which may be equipped with or in communication with sensors 320 as described below with reference to FIG. 3, is operable for delivering a charging voltage or current to the propulsion battery pack 12 over the electrical cable 18. A holster or cradle 23 located on the cabinet 22 is used to store the unused charge coupler 20 when the charge coupler 20 is not in use. To that end, the electrical cable 18 has a distal end 18D connected to the charging cabinet 22, and a proximal end 18P that is connected to the charge coupler 20. The charge coupler 20 in turn is configured to connect to the mating charge receptacle 15C of the EV 14 as appreciated in the art, e.g., a five-pin J1772 receptacle, or alternatively a CHAdeMO, CCS, or another application-suitable AC or DC receptacle. In the example of J1772, for instance, those skilled in the art will appreciate that the charge receptacle is equipped with corresponding receptacles for Line 1, Line 2/Neutral, Proximity/Pilot (12V), Control/Pilot (12V), and Ground, with the charge coupler 20 having corresponding charging pins 25 (see FIG. 2) for mating up with the charge receptacle 15C.

Still referring to FIG. 1, the EV 14 and the EVSE charging station 10 may include a corresponding electronic control unit or controller (C) 50 or 50A, respectively, for regulating the charging operation. To that end, input signals (arrow CCI) may be actively communicated or passively detected in different embodiments, such that the controllers 50, 50A are operable for determining a particular state of charge of the propulsion battery pack 12, an available charging voltage from the charging station 10, etc.

The controllers 50, 50A as contemplated herein are equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The controllers 50, 50A may include an associated computer-readable storage medium, i.e., non-transitory memory (M) inclusive of read only, programmable read only, random access, a hard drive, etc., whether resident, remote or a combination of both. Control routines are executed by the processor to monitor relevant inputs from sensing devices and other networked control modules (not shown), and to execute control and diagnostic routines to govern operation of the EV 14 and the EVSE charging station 10. The controller 50A in particular is also programmed to perform instructions embodying a method 100, an example of which is described below with reference to FIG. 3.

Referring now to FIG. 2, the charge coupler 20 includes a coupler body 200 having a handle 24 and a plug end 26. The plug end 26, which may be secured to the charge receptacle 15C of FIG. 1 via a latching mechanism and actuator 410, includes the plurality of charging pins 25, e.g., the five J1772 pins described above or another number or configuration of pins when the charge coupler 20 is of another competing charging standard. The handle 24, which is connected to the electrical cable 18 at the proximal end 18P thereof, is configured to be grasped by a user of the EV 14 of FIG. 1 during the charging process until the plug end 26 is securely connected to the charge receptacle 15C of FIG. 1.

Within the scope of the disclosure, at least one heating element 30 is connected to or embedded within the coupler body 200 and configured to selectively heat the coupler body 200 in response to communication of one or more activation signals (arrow CC_{A1}, C_{A2}) to the controller 50A. More specifically, the various heating elements 30 are configured to selectively heat the coupler body 200 as needed in response to a current environmental state of the charge coupler 20 being indicative of accumulated snow or ice thereon. At other times, such as in warmer weather, the heating function may be discontinued to conserve energy.

In a possible embodiment, the heating element(s) 30 may include at least one resistive heating element 30R, which in turn may be connected in series with a fuse 37 and an optional indicator device 39. Alternatively, the EVSE charging station 10 may include a coolant loop 30C operable for circulating heated coolant (arrows CC) through the charging cabinet 22 of FIG. 1, the electrical cable 18, and the charge coupler 20. The heating element(s) 30 in this instance may include the heated coolant (arrows CC) flowing through the various tubing or other fluid conduit (not shown) forming the coolant loop 30C.

Operation of the EVSE charging station 10 in one or more embodiments may rely on readings or measurements corresponding to the activation signals (arrows CC_{A1}, CC_{A2}). Such readings may be performed by a sensor 32 operable for detecting an environmental state of the charge coupler 20. In a possible implementation, the sensor(s) 32 may include a temperature sensor 33, in which case the environmental state may include a measured temperature of the charge coupler 20, e.g., of the coupler body 200 or the plug end 26, such as in proximity to charging pins 25. For instance, existing thermocouples or other temperature sensors used for monitoring the temperature of the charging pins 25 could be used for this purpose. In another embodiment, the sensor(s) 32 may include a humidity sensor 34, in which case the environmental state may include a relative humidity level of the charge coupler 20, such as inside or near the coupler body 200.

The heating element(s) 30 may also include a heating element 30, shown as a resistive heating element 30R in this non-limiting embodiment, that is positioned within the handle 24 and operable for warming the handle 24. While the same heating element 30 may be sized and positioned for both purposes, in other embodiments the charge coupler 20 may be equipped with a plurality of the resistive heating elements 30R, or the coolant loop 30C, or both, as will be appreciated by those skilled in the art. The above-noted indicator device 39, e.g., one or more LEDs, may be positioned on the handle 24 or elsewhere on the charge coupler 20 to provide the user with a visual indication of the active use of the heating element(s) 30, e.g., when selectively energizing the resistive heating element 30R with an electric current.

Referring to FIG. 3, instructions embodying the present method 100 may be recorded on a tangible, non-transitory computer-readable storage medium, e.g., the memory (M) described above, and executed by the processor (P) of the controller 50A shown in FIG. 1. An exemplary embodiment of the method 100 commences at block B101 (“*”) with initialization of the controller 50A, which could occur periodically or at regularly scheduled intervals to ensure that related buffers are cleared and temporary memory is refreshed. The method 100 then proceeds to block B102.

At block B102, the controller 50A determines the current external environmental conditions of the charge coupler 20 shown in FIG. 2. For instance, the sensor(s) 320 of FIG. 1 could be mounted to the charging cabinet 22 or another structure and configured to measure and/or receive information indicative of the current external environmental conditions, such as ambient temperature, barometric pressure, relative humidity, wind speeds, etc., in the general vicinity of the charging cabinet 22. Likewise, the charging cabinet 22 could be connected to the internet or another information source to monitor weather conditions. As the charging cabinet 22 is likely to be located outside and thus exposed at times to rain, sleet, ice, or snow, block B102 effectively evaluates whether local weather conditions favor an accumulation of snow and ice on exposed surfaces of the charge coupler 20 illustrated in FIG. 2. The method 100 proceeds to block B104 after the current external environmental conditions have been determined.

Block B104 entails determining current internal environmental conditions using the sensors 32 of FIG. 2. For example, the temperature sensor 33 may measure and report an internal or external temperature of the charge coupler 20, and/or the humidity sensor 34 may measure relative humidity levels within or near the charge coupler 20, i.e., the coupler body 200 thereof. Blocks B102 and B104 together effectively evaluate whether local and internal environmental conditions favor an accumulation of snow or ice on exposed surfaces of the charge coupler 20 illustrated in FIG. 2. The method 100 proceeds to block B106 upon completion of block B104.

At block B106, the processor (P) of the EVSE charging station 10 determines if the prevailing weather conditions warrant activation of the heating element(s) 30 of FIG. 2. Such a determination could entail comparing the measured values from blocks B102 and B104 to corresponding thresholds recorded in memory (M) of the controller 50A depicted in FIG. 1. As an example, a multi-dimensional lookup table populated with binary decision values of 0 and 1, or “ON” and “OFF”, could be accessed by local/external and internal readings from blocks B102 and B104, with the processor (P) of controller 50A referencing such a table to select the corresponding decision value. The method 100 may return to block B101 if conditions do not call for activation of the heating element(s) 30, such as when temperatures are above a predetermined level, e.g., 32° F. The method 100 instead proceeds to block B108 if conditions warrant activation of the heating element(s) 30.

At block B108, the controller 50A of FIG. 1 manages heating based on the current status of the charging cabinet 22. In a possible implementation, the processor (P) of the controller 50A could determine whether the charge coupler 20 is presently stowed in the cradle 23 of the charging cabinet 22 (a standby event) or connected to the EV 14 of FIG. 1 (a charging event). In a possible approach, the two events could have different heating profiles, perhaps with a sustained lower-temperature heating provided in standby and a temporarily elevated temperature provided during charging, or vice versa.

Likewise, changing weather conditions could cause the processor (P) of controller 50A to modify the heating profile in real-time, such as by increasing heating during a snow or ice storm. A possible implementation of the method 100 could therefore entail determining, via the controller 50A, whether the charge coupler 20 is presently stowed in the cradle 23 or connected to the EV 14, and thereafter executing a first heating profile when the charge coupler 20 is presently stowed in the cradle 23 of the charging cabinet 22, and executing a second heating profile when the charge coupler 20 is connected to the EV 14 of FIG. 1. The method 100 then proceeds to block B110.

Block B110 includes determining, via the controller 50A, whether the internal temperature of the charge coupler 20 of FIGS. 1 and 2 has reached a threshold temperature level. Such a threshold is a maximum permissible temperature level for the particular standby or charging event of block B108, and thus block B110 may entail performing a simple comparative process, e.g., using a comparator circuit. The method 100 proceeds to block B112 when the internal temperature of the charge coupler 20 has reached the noted threshold internal temperature, and instead returns to block B108 when the internal temperature remains below the threshold internal temperature.

Block B112 of FIG. 3 includes shutting off the heating element(s) 30. This action may entail a complete cessation of heating functions, e.g., by opening a switch (not shown) to cut off electric supply to the resistive heating element 30R of FIG. 2, activating a valve (not shown) to stop a flow of heated coolant through the charge coupler 20, etc. Alternatively, block B112 could involve lowering the level of heating to maintain the internal temperature of the coupler body 200, such as by reducing current flow through the resistive heating element 30R or reducing flow of the heated coolant instead of completely stopping it. The method 100 then returns to block B101 and repeats the above-described process.

As will be appreciated by those skilled in the art in view of the foregoing disclosure, the present teachings provide a myriad of benefits to users of the EVSE charging station 10 shown in FIG. 1 in locations that are subject to cold weather conditions. In addition to allowing the user to comfortably grasp the handle 24 of FIG. 2 during the charging process due to the internal warming of the charge coupler 20, inclusion of the heating element(s) 30 of FIG. 2 within the charge coupler 20, combined with intelligent weather-based activation decisions of the controller 50A, help to prevent the accumulation of snow and ice on surfaces of the charge coupler 20 prior to and during use.

Such an accumulation would be of particular concern at the plug end 26 of FIG. 2 due to possible interference with the mating contact connection to the EV 14 shown in FIG. 1 when connecting or disconnecting the charge coupler 20. As the controller 50A decides when to activate the heating element(s) 30, whether alone or in conjunction with communication with the controller 50 located aboard the EV 14 shown in FIG. 1, the use of the heating element(s) 30 remains condition-based and thus selective. For instance, periods of warm weather or direct sunlight may not require use of the heating element(s) 30, thereby allowing the described heating feature to be turned off to conserve energy. These and other attendant benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A charging station for charging a propulsion battery pack of an electric vehicle (EV), the charging station comprising:
a charging cabinet operable for providing a charging voltage or current to the propulsion battery pack during a charging operation of the EV;
an electrical cable having a distal end and a proximal end, wherein the distal end is connected to the charging cabinet; and
a charge coupler connected to the proximal end of the electrical cable and configured to connect to a charge receptacle of the EV, the charge coupler comprising a coupler body and at least one heating element connected to the coupler body, wherein the at least one heating element is configured to selectively heat the coupler body in response to an environmental state of the charge coupler being indicative of accumulated snow or ice on the charge coupler.

2. The charging station of claim 1, wherein the at least one heating element includes a resistive heating element.

3. The charging station of claim 1, further comprising:
a coolant loop operable for circulating a heated coolant through the charge coupler, wherein the heating element includes the heated coolant.

4. The charging station of claim 1, further comprising:
a sensor operable for detecting the environmental state of the charge coupler.

5. The charging station of claim 4, wherein the sensor includes a temperature sensor and the environmental state of the charge coupler includes a temperature of the charge coupler.

6. The charging station of claim 4, wherein the sensor includes a humidity sensor and the environmental state of the charge coupler includes a humidity level of the charge coupler.

7. The charging station of claim 1, wherein the charge coupler includes a plurality of charging pins, and wherein the at least one heating element includes one or more heating elements positioned proximate the plurality of charging pins.

8. The charging station of claim 1, wherein the charge coupler includes a handle, and wherein the at least one heating element includes at least one heating element positioned within the handle and operable for warming the handle.

9. A method for use with a charging station for charging a propulsion battery pack of an electric vehicle (EV), the charging station having a charge coupler, a charging cabinet, and an electrical cable connecting the charge coupler to the charging cabinet, the method comprising:
determining an environmental state of the charge coupler via a controller of the charging station using one or more sensors; and
selectively activating at least one heating element connected to the charge coupler in response to the environmental state being indicative of accumulated snow or ice on the charge coupler.

10. The method of claim 9, wherein the one or more sensors are connected to the charge coupler, the one or more sensors include a temperature sensor, and determining the environmental state of the charge coupler includes measuring a temperature of the charge coupler using the temperature sensor.

11. The method of claim 10, further comprising:
shutting off the at least one heating element in response to the temperature of the charge coupler having reached a threshold temperature level.

12. The method of claim 9, further comprising:
comparing the environmental state of the charge coupler to a corresponding threshold value, wherein selectively activating the at least one heating element occurs when the environmental state exceeds the corresponding threshold value.

13. The method of claim 9, wherein the at least one heating element includes a resistive heating element, and wherein selectively activating the at least one heating element includes selectively energizing the resistive heating element with an electric current.

14. The method of claim 9, wherein the charging station includes a coolant loop operable for circulating a heated coolant through the charge coupler, wherein the at least one heating element includes the heated coolant, and wherein selectively activating the heating element includes selectively circulating the heated coolant through the charge coupler.

15. The method of claim 9, wherein the one or more sensors include a humidity sensor, and wherein determining the environmental state of the charge coupler includes using the humidity sensor to measure a humidity level within or around the charge coupler.

16. The method of claim 9, further comprising:
determining, via the controller, whether the charge coupler is presently stowed in a cradle of the charging station or connected to the EV;
executing a first heating profile when the charge coupler is presently stowed in the cradle of the charging station; and
executing a second heating profile when the charge coupler is connected to the EV.

17. A charge coupler for use with a charging station when charging a propulsion battery pack of an electric vehicle (EV), the charge coupler comprising:
a coupler body having a plug end and a handle, wherein the plug end includes a plurality of charging pins configured to connect to a charge receptacle of the EV, and wherein the handle is connectable to a charging cabinet of the charging station via an electrical cable;
a sensor operable for detecting an environmental state of the charge coupler; and
at least one heating element connected to the coupler body, wherein the at least one heating element is configured to selectively heat the charge coupler in response to the environmental state being indicative of accumulated snow or ice on the charge coupler.

18. The charge coupler of claim 17, wherein the at least one heating element includes a resistive heating element.

19. The charge coupler of claim 17, further comprising:
a coolant loop operable for circulating a heated coolant through the charge coupler, wherein the at least one heating element includes the heated coolant.

20. The charge coupler of claim 17, wherein the at least one heating element includes a first heating element positioned proximate the plug end and a second heating element positioned proximate the handle.
